(19) United States
(12) Patent Application Publication
(10) Pub. No.: US 2013/0042544 A1
(43) Pub. Date: Feb. 21, 2013

(54) BIRD CONTROL SYSTEM

(71) Applicants: Gordon Sabine, Santa Monica, CA (US); Areanna Sabine, Santa Monica, CA (US)

(72) Inventors: Gordon Sabine, Santa Monica, CA (US); Areanna Sabine, Santa Monica, CA (US)

(21) Appl. No.: 13/015,401

(22) Filed: Jan. 27, 2011

Related U.S. Application Data
(63) Continuation-in-part of application No. 12/419,918, filed on Apr. 7, 2009, now abandoned.

(51) Int. Cl. A01M 29/32; E04B 1/72

(52) U.S. Cl. 52/101

(57) ABSTRACT

A bird repellent system comprising a shaft and shaft base installation securely fastened to a tower, wherein the shaft base comprises a tubular projection that is perpendicular to the shaft base into which the shaft is inserted and held upright. The shaft comprises bores running through the interior of the shaft, through which links can be formed to create a mesh or grid pattern to repel birds from landing or roosting and nesting on top of, or in, a tower structure. The shaft can comprise a cross-shape cross section whose base acts as a male part to a corresponding female part on the tubular projection to prevent the shaft from shifting around. Alternatively, the shaft can be screwed into, or fixedly connected to, a shaft base without the tubular projection. The shaft base can be securely fastened to the tower structure with screws, cords, nails, straps and/or magnets.

### CROSS-REFERENCE TO RELATED APPLICATION

This application is a continuation-in-part of application Ser. No. 12/419,918 filed by the same inventors, and claims the benefit of this prior non-provisional application filed on Apr. 7, 2009.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FEDERALLY SPONSORED RESEARCH

Not Applicable

### SEQUENCE LISTING OR PROGRAM

Not Applicable

### BACKGROUND

The present invention generally relates to bird repellent systems. Bird repellant articles, devices, and systems are known in the art. Commonly known devices are installed on towers, areas with a large pedestrian population, or other buildings with signs. For example, U.S. Pat. No. 6,622,436 to Kretsch discloses a method of deterring waterfowl trespassing with a barrier consisting in its simplest form of a pair of lines suspended above a property surface, with one line at 3 to 10 inches high, a second line at 8 to 30 inches high, and a separation between the lines of at least 5 inches. The lines are suspended by means of an array of posts. Preferably, a dispenser for feeding a line from a spool and also for retracting the line is mounted on one of the posts. The barrier is optimally removable, including means for retracting the line and for conveniently removing the posts from receptacles in the property surface. While Kretsch seeks to deter trespass by geese on foot, it is not designed to stop birds from roosting on structures above ground.

Also known are wires and metallic spikes placed atop structures such as shopping centers and building signs to stop pigeons from nesting, and to prevent pigeon droppings. For example, U.S. Pat. No. 4,937,988 to Gratton discloses a barrier for preventing pigeons from landing on a balcony rail comprising a pair of support brackets adapted for flush mounting to opposite ends of the balcony rail, and a plurality of monofilament wires secured between the pair of support brackets. Gratton is specifically adapted for balcony railings and is designed to serve as a more permanent barrier that cannot easily be removed if maintenance or construction activities were to take place.

Both Gratton and Kretsch are also insufficient in that they constitute “fences” only, which may not deter birds from landing behind the “fences” (e.g., inside a large balcony).

There is a special need for deterring birds other than just pigeons from roosting or nesting on other types of structures, and for reasons other than to prevent pigeon droppings. For example, birds that nest on transmission towers obstruct workers from conducting maintenance and construction activities on the towers, causing costly delays. Birds also roost on power poles and interfere with transmission lines, causing electrical damage and outages that interfere with homes and businesses. Furthermore, airport towers require bird repellents to deter birds from landing and to thereby avoid aircraft collisions. At the same time, these structures require a non-metallic repellent that does not interfere with transmissions, and since the type of bird that interferes with a tower can vary by location, the bird barrier must be adjustable to target different kinds of birds, and not just pigeons and geese. Because most birds are federally protected, it is necessary to create a barrier that only repels birds without injuring them, and since it is possible for birds to land behind a fence, the barrier must be sufficient to prevent this from happening.

The problem of deterring birds from roosting and nesting on transmission towers, including television towers, radio towers, cell phone and communication towers, electrical towers, electrical power poles, FAA and airport communication and antenna towers, radar and weather platforms, airport runway signs and other airfield installations, is solved by a non-metallic barrier comprising shaft bases with shafts that can be easily removed by workers when performing maintenance or construction activities, and that comprise bores through which cords can be woven into various grid patterns to deter birds of various sizes, including ospreys, harriers, hawks, eagles, falcons, owls, herons, egrets, bitterns, vultures, California condors, Ibises, pelicans, cormorants, and gulls, from landing on top of, and/or in, structures.

### SUMMARY

The present invention comprises a non-metallic bird repellent system. The system comprises a shaft having a longitudinal tubular surface, wherein at least one bore disposed latitudinal on the tubular surface of the shaft is utilized for creating multiple links and grid patterns between the shafts.

A shaft base having an arched horizontal member comprises a tubular projection from the outer surface and perpendicular to the arched horizontal member, wherein the tubular projection comprises a tubular recess disposed along the central longitudinal axis of the tubular projection and is in continuous contact with the arched horizontal member along the entire length of the tubular projection for holding the shaft upright.

The shaft inserts into the tubular recess of the shaft base and is held upright, wherein the shaft base is fastened to a transmission tower by means of a cord, nail, screw, strap, or similar means.

Links between the installed shaft and shaft base with cords comprise a mesh or grid pattern (e.g., horizontal cords intersected by vertically placed shafts) between shafts, comprising a cord strung through all the bores on the shafts and securely knotted. This link system creates a mesh or grid pattern (e.g., horizontal cords intersected by vertically placed shafts), between multiple shafts.

In one preferred embodiment of the invention, the shaft base is angled and in another preferred embodiment, the shaft base is flat.

While the shafts may have different tips, the preferred embodiment of the shaft has a cross-shaped cross section so that the bottom end of the shaft acts as a male part which can be inserted into the tubular recess, wherein at the base of the tubular projection there is a female part. The insertion of the male part of the shaft and the female part of the tubular projection prevents the shaft from shifting.

In another preferred embodiment, the shaft base has a magnet for holding the shaft base stable on a metallic surface.

### BRIEF DESCRIPTION OF THE FIGURES

FIG. 1 shows a base a shorten shaft of the present invention.

FIG. 1b shows a base, sleeve, and shortened shaft of the present invention.

FIG. 2 is a cut away view of the present invention showing alternate installation locations.

FIG. 3a-3c shows various embodiments of shaft tips in perspective view of the present invention.

FIG. 4a shows a close up view of the invention from an angle

FIG. 4b shows a close up view of an alternate embodiment of the invention.

FIG. 5 shows an example of a grid pattern that can be formed by linking shafts with a cord.

FIG. 6a is a perspective view of the present invention installed on an electrical power pole.

FIG. 6b is a perspective view of the shaft base of the present invention having two bores.

FIG. 7 is a perspective view of a preferred embodiment of the invention with a different shaft and shaft base.

FIG. 8 is a perspective view of a preferred embodiment of the shaft.

FIG. 9 is a perspective view of a preferred embodiment of the invention with a cutaway view of the tubular projection showing the insertion of the male part of the shaft into the female part of the tubular projection.

FIG. 10 is a top view of a preferred embodiment of the invention wherein a female part can be seen at the base of the tubular projection.

FIG. 11 is another preferred embodiment of the invention for flat surfaces and that comprises a magnet.

FIG. 12 is a bottom view of the preferred embodiment of the invention with a shaft base that comprises a magnet.

FIG. 13 is a perspective view of the different parts of the shaft base that comprises a magnet.

### REFERENCE NUMERALS

10 . . . shaft
10a . . . first tip
10b . . . second tip
10c . . . third tip
11 . . . stopper
12 . . . bore
12a . . . bore on shaft base
12b . . . horizontal insertion points on shaft base
13 . . . strap
14 . . . tubular projection
14a . . . sleeve
15 . . . tubular recess
16 . . . shaft base
17a . . . knot
20a . . . cord
20b . . . cord or strap
21 . . . male part
22 . . . female part
30 . . . tower structures utilizing circular or square tubing
100 . . . the system
200 . . . mesh or grid pattern
300 . . . electrical power pole

### DETAILED DESCRIPTION

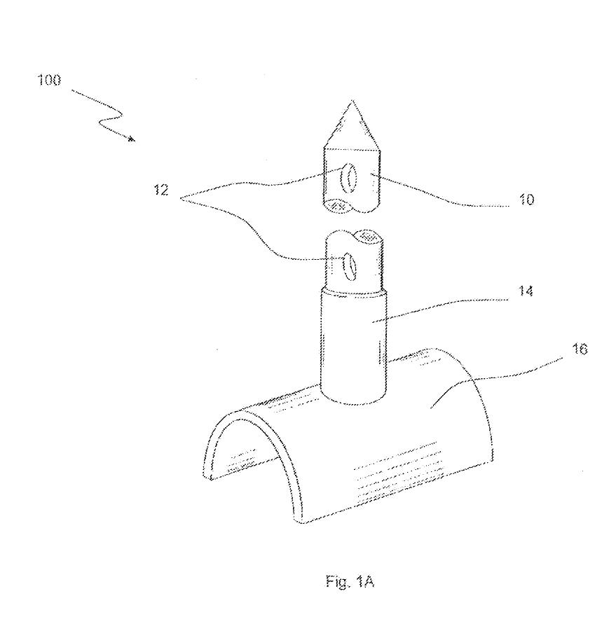

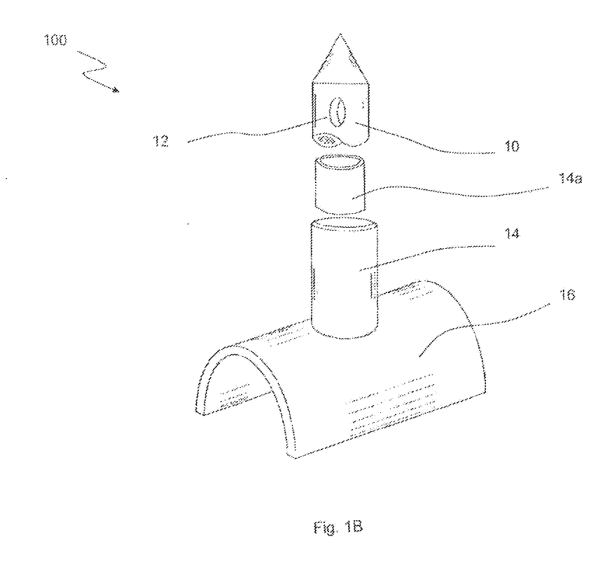

Referring to FIG. 1a, a bird repellent system is shown and described. In the preferred embodiment, the system 100 comprises a shaft 10 having a longitudinal round surface, wherein at least one bore 12 disposed latitudinal on the round surface of the shaft 10 is utilized for creating multiple links between shafts 10.

Still referring to FIG. 1a, a shaft base 16 having an arched horizontal member comprising a tubular projection 14 from the outer surface and perpendicular to the horizontal member, wherein the tubular projection 14 comprises a tubular recess disposed along the central longitudinal axis of the tubular projection 14 and is in continuous contact with the horizontal member of the shaft base 16 along the entire length of the tubular projection 14 for holding the shaft 14 upright.

Referring to FIG. 1b, an alternate embodiment of the invention comprises a two piece tubular projection 14 in which the tubular projection comprises another piece inserted into the tubular projection, called the sleeve 14a, which lengthens the tubular projection 14 thereby adding support for the shaft 10.

Referring back to FIG. 1a of the system 100, an alternate embodiment of the invention comprises a tubular projection 14 with a bore 12 that corresponds to the bore 12 of the shaft 14 when the shaft 14 is inserted into the tubular projection 14. A cable tie 20a can be inserted through the bore of the tubular projection and the bore of the shaft to secure the shaft 14 and shaft base 16

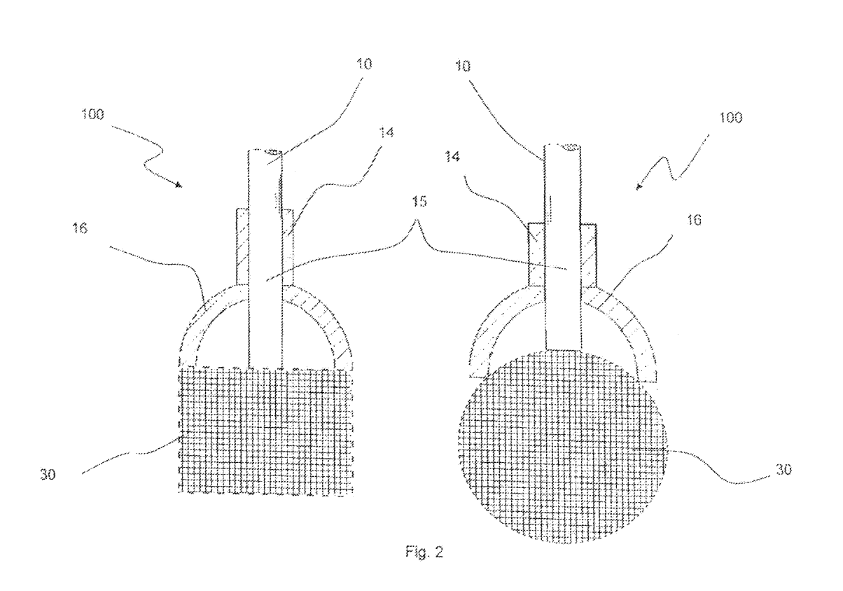

Referring to FIG. 2 of the system 100, the shaft 10 inserts into the tubular recess 15 of the shaft base 16 and is held upright. The shaft base 16 may be installed on tower 30 structures that utilize circular or square tubing 30.

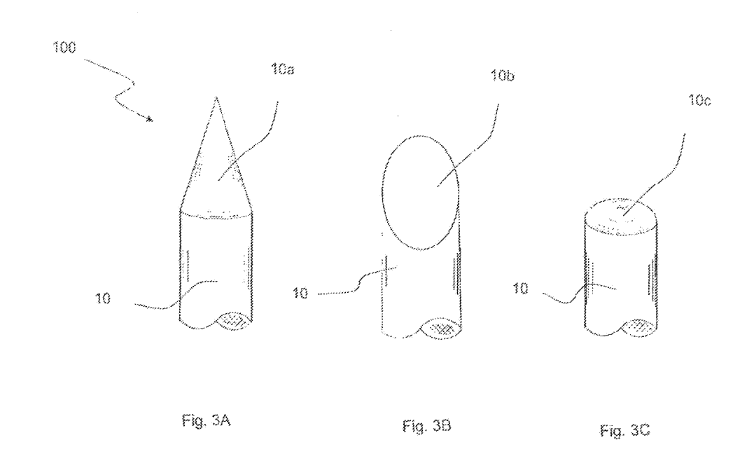

Referring to FIG. 3a-3b of the system 100, alternate embodiments of shaft 10 tips are shown. The first tip 10a comprises a smooth cone shaped surface. The second tip 10b comprises an angled surface. The third tip 10c comprises a flat latitudinal surface.

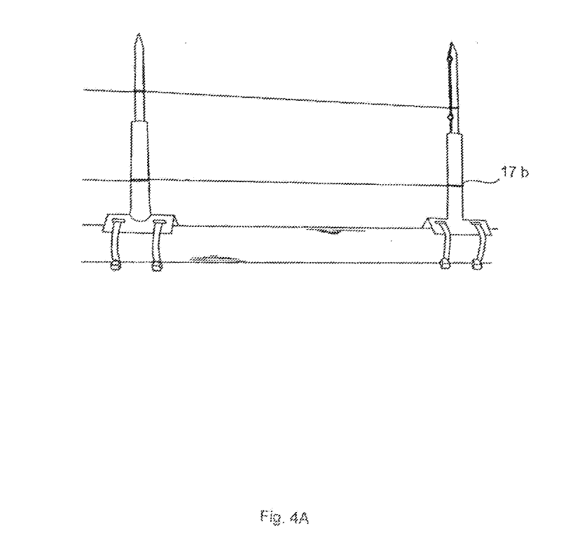

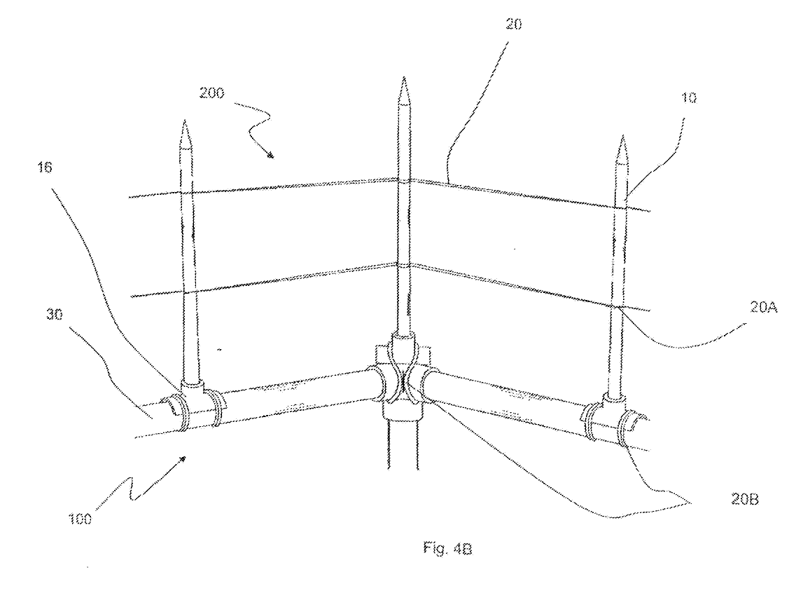

Referring to FIG. 4a of the system 100, the shaft base 16 is fastened to a communication and/or transmission tower 30 of interest by means of a cord or strap 20b and the shafts are linked together by cords 20a. FIG. 4a shows an alternate embodiment of the invention wherein the shaft base is fastened to a communication and/or transmission tower 30 and a cord 20 forms a link between the shafts through the bores of both the shafts and the tubular projections by forming a knot 17a. Linking the shafts through the tubular projections means that the link can be formed at a lower level, thereby helping to repel smaller birds from landing on a communication and/or transmission tower.

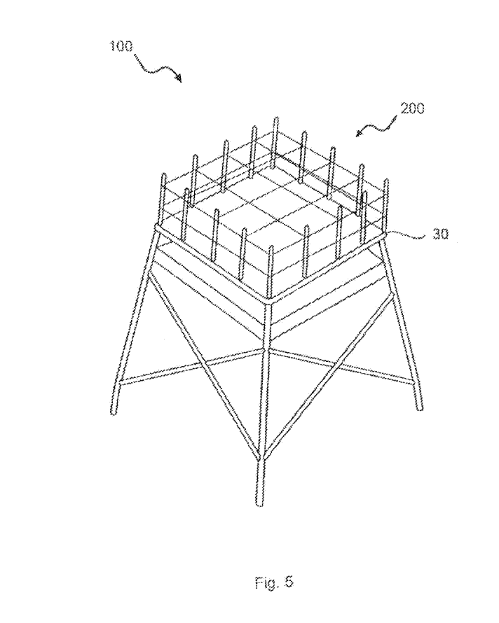

Still referring to FIGS. 4 and 4a, and also to FIG. 5 of the system 100, links between installed shafts 10 with cords 20a comprise a mesh 200 or grid pattern wherein the cord 20a is strung through all the bores 12 on the shafts 10 and securely fastened with a knot 17a. It should be noted that a cord, rope or other means of linking can be substituted for each other as long as it can form a link between the shafts and tubular projections or tie the shaft base to a communication and/or transmission tower.

Referring to FIG. 5 of the system 100, one example of a mesh 200 or grid pattern is shown. The mesh or grid pattern 200 can be used not only to create fencing to block off access from the sides, but also to cover the tops of structures to block off access from above.

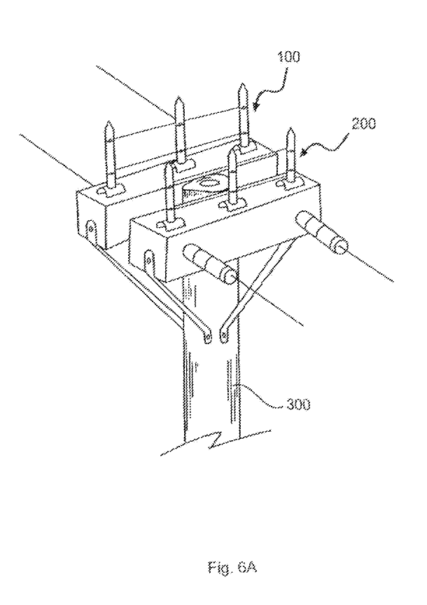

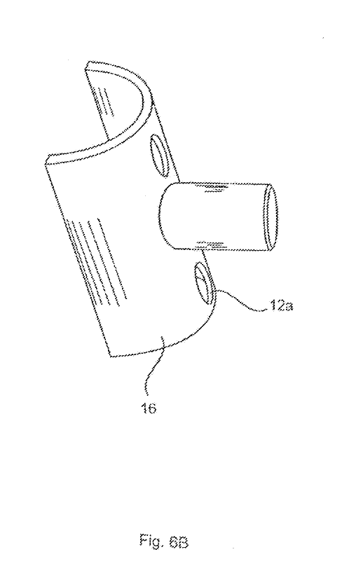

Referring to FIGS. 6a and 6b of the system 100, an alternative embodiment of the shaft base 16 comprises two bores 12a on a horizontal shaft base through which nails or screws may be inserted to fasten the shaft member to a wooden horizontal surface such as an electrical power pole 300.

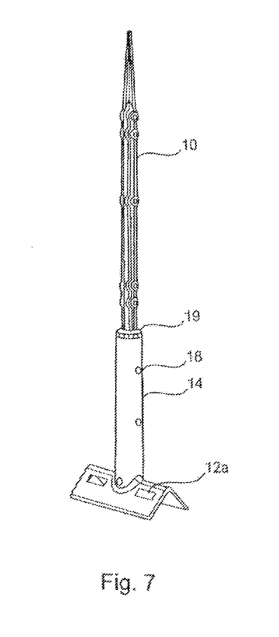

FIG. 7 is a preferred embodiment of the invention shown with a horizontal and angled shaft base and a shaft with a cross-shaped cross section. The angled shaft base allows the shaft base to be tied to electrical power poles 300 of different circumferences. Instead of nails or screws for fastening the shaft base onto an electrical power pole 300, horizontal insertion points 12b are present on the shaft base. Referring back to FIG. 4b, a strap 13 can be inserted to fasten the shaft base to an electrical power pole 300.

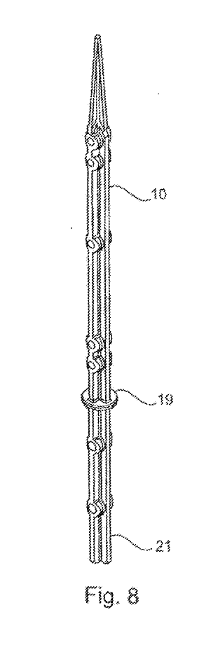

Still referring to FIG. 7 and also to FIG. 8, the shaft 10 of the alternate embodiment has a cross-shaped cross section, and a stopper 11 at the midsection of the shaft 10. The stopper 11 prevents liquid and objects from falling inside of the tubular recess 15. The cross-shaped cross section of the shaft 10 acts as a male part 21 at the bottom end of the shaft which can be inserted into the base of the tubular projection which acts as a female part 22. The insertion of the male part 21 of the shaft 10 into the female part 22 of the tubular projection 14 prevents the shaft 10 from shifting around.

It is also perceivable that the shaft can be screwed into the tubular cross section or shaft base. If the shaft is screwed into the shaft member or otherwise fixedly connected to the shaft member, the tubular projection may be unnecessary.

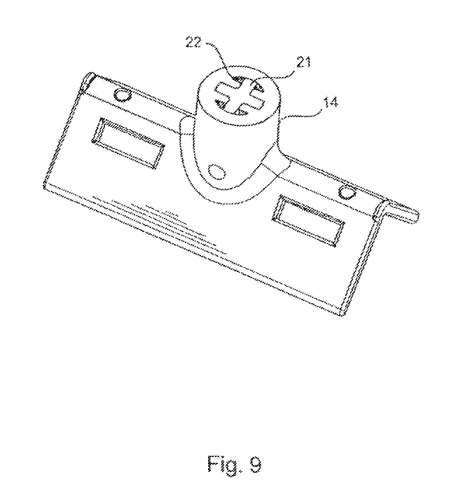

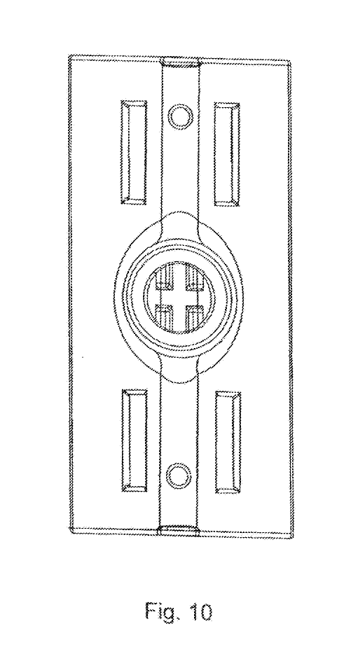

FIG. 9 shows a cut-away section of the tubular projection at the base where the male part 21 of the shaft 10 is inserted into the female part 22 of the tubular projection. FIG. 10 is a top view of a shaft base 16 with a female part.

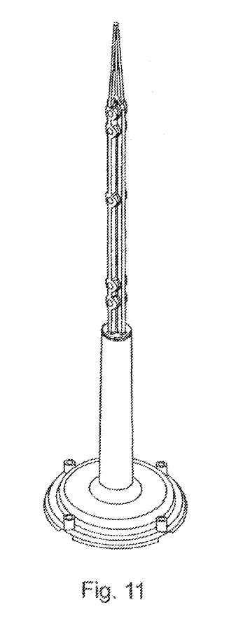

FIG. 11 shows another preferred embodiment of the invention in which the shaft base is adapted for flat surfaces, wherein the shaft base is round and flat, and a plurality of bores 12a on the shaft base allows the shaft base 16 to be fastened onto a flat surface.

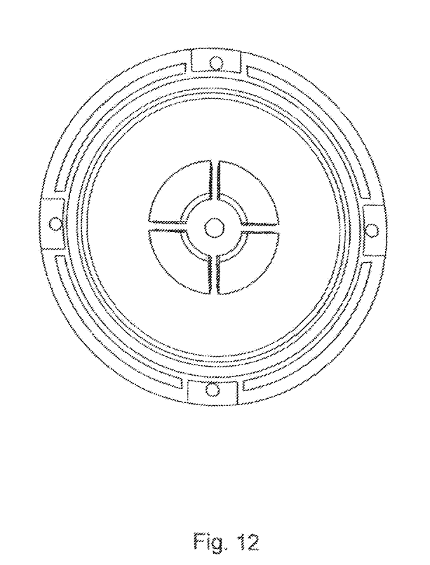

FIG. 12 shows a bottom view of a round and flat shaft base 16 in which a magnet 22 is inserted in the bottom of the shaft base 16 so that the shaft base is stable on a metallic surface.

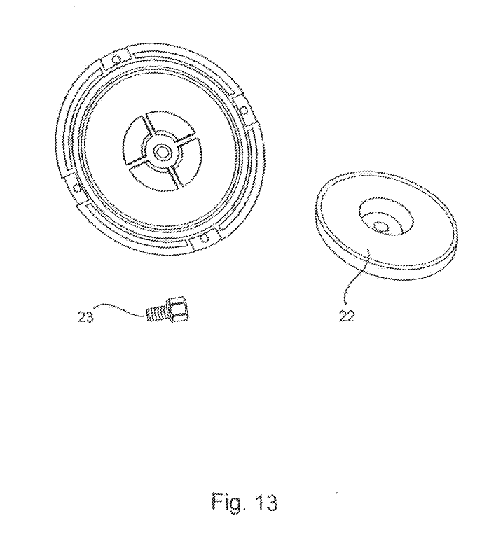

FIG. 13 shows the different parts of a shaft base with a magnet, comprising a magnet and screw.

FIG. 8 is a perspective view of the preferred embodiment of the shaft having a cross-shaped cross section and stopper.

FIG. 9 is a perspective view of the preferred embodiment of the shaft base depicting a cross section of the base of the tubular projection showing the shaft's male part inserted into the tubular projection's female part.

FIG. 10 shows a top view of the angled shaft base and the base of the tubular projection, showing the male part of the shaft inserted into the female part of the tubular projection.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A bird repellent system, comprising:
a. a shaft comprising wherein the latitudinal surface of the shaft comprises at least one bore passing through the interior of the shaft to the other side of the shaft;
b. a shaft base having a tubular projection holding the shaft upright, wherein the tubular projection comprises a tubular recess disposed centrally and longitudinally through the tubular projection wherein the tubular projection is in continuous contact with the shaft base along the entire length of the tubular projection;
c. a means for linking at least two shafts, including at least one cord or cord equivalent, including a wire or rope, that is inserted through the at least one bore passing through the interior of the shaft and securely knotted to at least one shaft;
d. a means for fastening the shaft and/or shaft base to a tower structure, including a strap, cord, nails, screws, or adhesive; and
e. a bird repellent setup wherein the combination of at least two shafts linked together by the means for linking at least two shafts forms a mesh or grid pattern for repelling birds known to land on a tower structure.

2. The system of claim 1, wherein the shaft and shaft base form an installation wherein the shaft base can be securely tied to a communication tower, and wherein the shaft is inserted into the tubular recess of the shaft base and held upright.

3. The system of claim 1, wherein all parts are non-metallic.

4. The system of claim 1, wherein the tubular projection is comprised of two pieces, including a sleeve.

5. The system of claim 1, wherein the tip of the shaft is pointed, angled, or flat.

6. The system of claim 1, wherein the shaft base is arched, angled, or flat

7. The system of claim 1, wherein the tubular projection is perpendicular to the shaft base.

8. The system of claim 1, wherein the shaft has a cross-shaped cross section.

9. The system of claim 1, wherein the shaft has a stopper in its midsection to prevent objects and liquids from entering the tubular projection.

10. The system of claim 1, wherein the shaft has a male part that is inserted into a female part of the tubular projection to prevent the shaft from shifting around.

11. The system of claim 1, wherein the shaft base comprises a means for fastening the shaft base to a surface, including at least one bore, at least one insertion point for a strap, a magnet, or an adhesive.

12. The system of claim 11, wherein the magnet is fastened to the shaft base.

13. The system of claim 1, wherein the means for linking at least two shafts comprises a bore on the tubular projection of the shaft base that corresponds to a bore of the shaft, in which a link is inserted through the bores of both the tubular projection and the shaft and a knot is formed.

14. The system of claim 1, wherein the shaft is screwed into, or fixedly connected to, the tubular projection.

15. A bird repellent system, comprising:
a. a shaft comprising wherein the latitudinal surface of the shaft comprises at least one bore passing through the interior of the shaft to the other side of the shaft;
b. a shaft base holding the shaft upright;
c. a means for linking at least two shafts, including at least one cord or cord equivalent, including a wire or rope, that is inserted through the at least one bore passing through the interior of the shaft and securely knotted to at least one shaft;
d. a means for fastening the shaft and/or shaft base to a tower structure, including a strap, cord, nails, screws, or adhesive; and
e. a bird repellent setup wherein the combination of at least two shafts linked together by the means for linking at least two shafts forms a mesh or grid pattern for repelling birds known to land on a tower structure;
wherein the shaft is screwed into, or otherwise fixedly connected to, the shaft base.

16. The system of claim 15, wherein the shaft base is arched, angled, or flat.

17. The system of claim 15, wherein the shaft has a cross-shape cross section.

18. The system of claim 15, wherein the shaft is screwed into, or fixedly connected to, the shaft base.

19. The system of claim 15, wherein the shaft base comprises a means for fastening the shaft base to a surface, including at least one bore, at least one insertion point for a strap, nails, a magnet, or an adhesive.

20. The system of claim 15, wherein the magnet is fastened to the shaft base.
